(19) United States
(12) Patent Application Publication
(10) Pub. No.: US 2024/0204266 A1
(43) Pub. Date: Jun. 20, 2024

(54) ENERGY STORAGE SYSTEM

(71) Applicant: SAMSUNG SDI CO., LTD., Yongin-si (KR)

(72) Inventor: Jiwon YOO, Yongin-si (KR)

(21) Appl. No.: 18/488,905

(22) Filed: Oct. 17, 2023

(30) Foreign Application Priority Data
Dec. 20, 2022 (KR) 10-2022-0179721

(51) Int. Cl. H01M 10/42; H01M 50/298

(52) U.S. Cl. CPC H01M 10/425; H01M 50/298; H01M 2010/4271; H01M 2010/4278

(57) ABSTRACT

The present disclosure relates to an energy storage system. The energy storage system may include a battery system configured to include battery banks electrically connected to each other, and battery management systems including first and second ports for transmission control protocol/Internet protocol (TCP/IP) or user datagram protocol (UDP) communication, the battery management systems being configured to communicate with the battery banks, configured to receive state data from a corresponding one of the battery banks, and configured to communicate in a daisy chain manner with one another.

### CROSS-REFERENCE TO RELATED APPLICATIONS

This application claims priority to, and the benefit of, Korean Patent Application No. 10-2022-0179721 filed Dec. 20, 2022, in the Korean Intellectual Property Office, the entire contents of which are incorporated herein by reference.

### BACKGROUND

### 1. Field

The present disclosure relates to an energy storage system.

### 2. Description of Related Art

An energy storage system (ESS) is a system that increases energy efficiency by storing a relatively large amount of electrical energy, and by supplying the stored electrical energy when electrical energy is needed.

Typically, the ESS may include a battery system, a battery management system (BMS) configured to manage the battery system, such as monitoring a voltage, current, temperature, etc. of the battery system, a power conversion system (PCS) configured to perform alternating-current-to-direct-current (AC-DC) conversion and distribution functions, an energy management system (EMS) configured to control an entire system of the ESS in an integrated manner, such as to control an energy flow of the ESS and to collect and manage information related to a status of the ESS. In addition, the battery system may include a plurality of battery racks electrically connected to each other. Each of the battery racks includes a plurality of battery modules electrically connected to each other, and each of the battery modules may include a plurality of cells electrically connected to each other.

In general, data transmission is performed between the BMS and the battery racks through controller area network (CAN) communication for safety and noise preparation. Accordingly, as a number of battery racks transmitting data to the BMS increases, transmission delay due to CAN communication increases. In addition, as a number of battery cells constituting each of the battery racks increases, a size of data processed by each battery rack and transmitted to the BMS also increases, so transmission delay may increase.

Recently, due to a safety issue of the ESS, a larger amount of information processing and faster transmission speed are suitable. Accordingly, conventionally, a method of limiting a scale of a battery system managed by one PCS has been used. However, when the scale of the battery system is limited, there is a limit to an application of the battery system, and thus another method for improving the data transmission speed of the ESS is suitable.

### SUMMARY

An aspect of the present disclosure provides an energy storage system (ESS) with improved data transfer speed from a battery system to a BMS.

One or more embodiments of the present disclosure provide an energy storage system including a battery system configured to include battery banks electrically connected to each other, and battery management systems including first and second ports for transmission control protocol/Internet protocol (TCP/IP) or user datagram protocol (UDP) communication, the battery management systems being configured to communicate with the battery banks, configured to receive state data from a corresponding one of the battery banks, and configured to communicate in a daisy chain manner with one another.

The battery management systems may be configured to perform communication as a server using the first port, and to perform communication as a client using the second port.

IDs may be respectively assigned to the battery management systems, wherein IPs of the battery management systems are set according to the IDs.

IDs may be respectively assigned to the battery management systems, wherein data zones in a transmission frame are respectively allocated according to the IDs.

The battery management systems may be configured to update the transmission frame by adding the state data of a corresponding one of the battery banks to the transmission frame, and to transmit the updated transmission frame to one of the battery management systems of an upper stage.

If the transmission frame is received from one of the battery management system of a lower stage, the battery management systems may be configured to update the transmission frame by adding the state data of a corresponding one of the battery banks to the transmission frame received from the one of the battery management systems of the lower stage.

A master battery management system of the battery management systems may be configured to receive, from the one of the battery management systems of the lower stage, the transmission frame including the state data added by at least one slave battery management system of the battery management systems.

The energy storage system may further include an energy management system configured to integrally manage an operation of the energy storage system, to communicate with the master battery management system through TCP/IP or UDP communication, and to access the master battery management system to receive the transmission frame from the master battery management system.

The battery banks may include racks electrically connected to each other and configured to communicate with each other through controller area network (CAN) communication, wherein the battery management systems are configured to receive the state data obtained from battery modules constituting a corresponding one of the racks in a daisy-chain manner based on CAN communication.

According to the present disclosure, transmission delay until a BMS collects data of battery racks constituting a battery system may be reduced. Accordingly, it is possible to increase a capacity of the battery system, and also to increase an amount of data processing.

### BRIEF DESCRIPTION OF THE DRAWINGS

FIG. 1 schematically illustrates an energy storage system according to one or more embodiments.

FIG. 2 illustrates a view for describing a communication method between battery management systems in an energy storage system according to one or more embodiments.

FIG. 3 illustrates a view for describing a method of transferring rack data collected by battery management systems in an energy storage system according to one or more embodiments.

### DETAILED DESCRIPTION

Aspects of some embodiments of the present disclosure and methods of accomplishing the same may be understood more readily by reference to the detailed description of embodiments and the accompanying drawings. Hereinafter, embodiments will be described in more detail with reference to the accompanying drawings. The described embodiments, however, may have various modifications and may be embodied in different forms, and should not be construed as being limited to only the illustrated embodiments herein. Further, each of the features of the various embodiments of the present disclosure may be combined or combined with each other, in part or in whole, and technically various interlocking and driving are possible. Each embodiment may be implemented independently of each other or may be implemented together in an association. The described embodiments are provided as examples so that this disclosure will be thorough and complete, and will fully convey the aspects of the present disclosure to those skilled in the art, and it should be understood that the present disclosure covers all the modifications, equivalents, and replacements within the idea and technical scope of the present disclosure. Accordingly, processes, elements, and techniques that are not necessary to those having ordinary skill in the art for a complete understanding of the aspects of the present disclosure may not be described.

Unless otherwise noted, like reference numerals, characters, or combinations thereof denote like elements throughout the attached drawings and the written description, and thus, descriptions thereof will not be repeated. Further, parts that are not related to, or that are irrelevant to, the description of the embodiments might not be shown to make the description clear.

In the drawings, the relative sizes of elements and regions may be exaggerated for clarity. As such, variations from the shapes of the illustrations are to be expected. Further, specific structural or functional descriptions disclosed herein are merely illustrative for the purpose of describing embodiments according to the concept of the present disclosure. Thus, embodiments disclosed herein should not be construed as limited to the illustrated shapes of regions, but are to include deviations in shapes.

Thus, the regions illustrated in the drawings are schematic in nature and their shapes are not intended to illustrate the actual shape of a region of a device and are not intended to be limiting. Additionally, as those skilled in the art would realize, the described embodiments may be modified in various ways, all without departing from the spirit or scope of the present disclosure.

In the detailed description, for the purposes of explanation, numerous specific details are set forth to provide a thorough understanding of various embodiments. It is apparent, however, that various embodiments may be practiced without these specific details or with one or more equivalent arrangements. In other instances, well-known structures and devices are shown in block diagram form to avoid unnecessarily obscuring various embodiments.

It will be understood that when an element, layer, region, or component is referred to as being “formed on,” “on,” “connected to,” or “(operatively or communicatively) coupled to” another element, layer, region, or component, it can be directly formed on, on, connected to, or coupled to the other element, layer, region, or component, or indirectly formed on, on, connected to, or coupled to the other element, layer, region, or component such that one or more intervening elements, layers, regions, or components may be present. In addition, this may collectively mean a direct or indirect coupling or connection and an integral or non-integral coupling or connection. For example, when a layer, region, or component is referred to as being “electrically connected” or “electrically coupled” to another layer, region, or component, it can be directly electrically connected or coupled to the other layer, region, and/or component or intervening layers, regions, or components may be present. However, “directly connected/directly coupled,” or “directly on,” refers to one component directly connecting or coupling another component, or being on another component, without an intermediate component. In addition, in the present specification, when a portion of a layer, a film, an area, a plate, or the like is formed on another portion, a forming direction is not limited to an upper direction but includes forming the portion on a side surface or in a lower direction. On the contrary, when a portion of a layer, a film, an area, a plate, or the like is formed “under” another portion, this includes not only a case where the portion is “directly beneath” another portion but also a case where there is further another portion between the portion and another portion. Meanwhile, other expressions describing relationships between components, such as “between,” “immediately between” or “adjacent to” and “directly adjacent to” may be construed similarly. In addition, it will also be understood that when an element or layer is referred to as being “between” two elements or layers, it can be the only element or layer between the two elements or layers, or one or more intervening elements or layers may also be present.

For the purposes of this disclosure, expressions, such as “at least one of,” or “any one of,” or “one or more of” when preceding a list of elements, modify the entire list of elements and do not modify the individual elements of the list. For example, “at least one of X, Y, and Z,” “at least one of X, Y, or Z,” “at least one selected from the group consisting of X, Y, and Z,” and “at least one selected from the group consisting of X, Y, or Z” may be construed as X only, Y only, Z only, any combination of two or more of X, Y, and Z, such as, for instance, XYZ, XYY, YZ, and ZZ, or any variation thereof. Similarly, the expression, such as “at least one of A and B” and “at least one of A or B” may include A, B, or A and B. As used herein, “or” generally means “and/or,” and the term “and/or” includes any and all combinations of one or more of the associated listed items. For example, the expression, such as “A and/or B” may include A, B, or A and B. Similarly, expressions, such as “at least one of,” “a plurality of,” “one of,” and other prepositional phrases, when preceding a list of elements, modify the entire list of elements and do not modify the individual elements of the list.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure. The description of an element as a “first” element may not require or imply the presence of a second element or other elements. The terms “first,” “second,” etc. may also be used herein to differentiate different categories or sets of elements. For conciseness, the terms “first,” “second,” etc. may represent “first-category (or first-set),” “second-category (or second-set),” etc., respectively.

The terminology used herein is for the purpose of describing particular embodiments only and is not intended to be limiting of the present disclosure. As used herein, the singular forms “a” and “an” are intended to include the plural forms as well, while the plural forms are also intended to include the singular forms, unless the context clearly indicates otherwise. It will be further understood that the terms “comprises,” “comprising,” “have,” “having,” “includes,” and “including,” when used in this specification, specify the presence of the stated features, integers, steps, operations, elements, and/or components, but do not preclude the presence or addition of one or more other features, integers, steps, operations, elements, components, and/or groups thereof.

When one or more embodiments may be implemented differently, a specific process order may be performed differently from the described order. For example, two consecutively described processes may be performed substantially at the same time or performed in an order opposite to the described order.

As used herein, the term “substantially,” “about,” “approximately,” and similar terms are used as terms of approximation and not as terms of degree, and are intended to account for the inherent deviations in measured or calculated values that would be recognized by those of ordinary skill in the art. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within +30%, 20%, 10%, 5% of the stated value. Further, the use of “may” when describing embodiments of the present disclosure refers to “one or more embodiments of the present disclosure.”

The electronic or electric devices and/or any other relevant devices or components according to embodiments of the present disclosure described herein may be implemented utilizing any suitable hardware, firmware (e.g., an application-specific integrated circuit), software, or a combination of software, firmware, and hardware, to process data or digital signals. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or formed on one substrate. Circuit hardware may include, for example, application specific integrated circuits (ASICs), general purpose or special purpose central processing units (CPUs) that is configured to execute instructions stored in a non-transitory storage medium, digital signal processors (DSPs), graphics processing units (GPUs), and programmable logic devices, such as field programmable gate arrays (FPGAs).

Further, the various components of these devices may be a process or thread, running on one or more processors, in one or more computing devices, executing computer program instructions and interacting with other system components for performing the various functionalities described herein. The computer program instructions are stored in a memory that may be implemented in a computing device using a standard memory device, such as, for example, a random-access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the spirit and scope of the embodiments of the present disclosure.

Some embodiments are described in the accompanying drawings in relation to functional block, unit, and/or module. Those skilled in the art will understand that such block, unit, and/or module are/is physically implemented by a logic circuit, an individual component, a microprocessor, a hard wire circuit, a memory element, a line connection, and other electronic circuits. This may be formed using a semiconductor-based manufacturing technique or other manufacturing techniques. The block, unit, and/or module implemented by a microprocessor or other similar hardware may be programmed and controlled using software to perform various functions discussed herein, optionally may be driven by firmware and/or software. In addition, each block, unit, and/or module may be implemented by dedicated hardware, or a combination of dedicated hardware that performs some functions and a processor (for example, one or more programmed microprocessors and related circuits) that performs a function different from those of the dedicated hardware. In addition, in some embodiments, the block, unit, and/or module may be physically separated into two or more interact individual blocks, units, and/or modules without departing from the scope of the present disclosure. In addition, in some embodiments, the block, unit and/or module may be physically combined into more complex blocks, units, and/or modules without departing from the scope of the present disclosure.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

Hereinafter, a battery system and an energy storage system (ESS) including the same according to embodiments will be described in detail with reference to drawings.

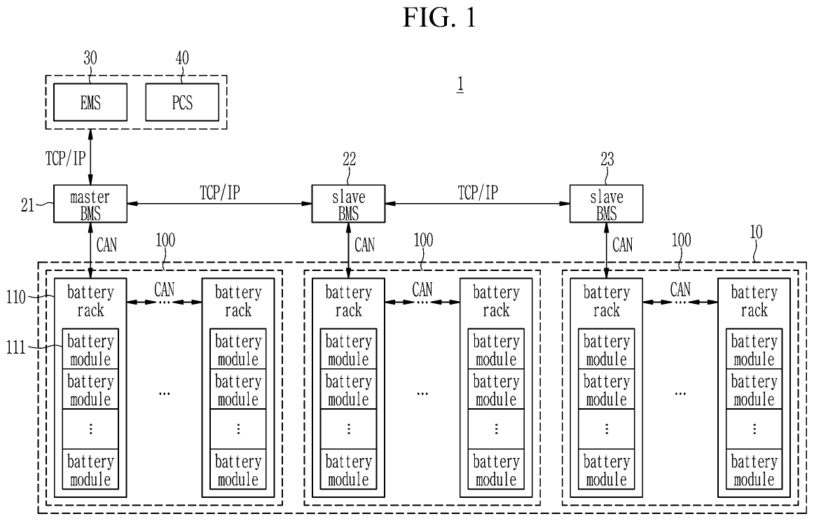

FIG. 1 schematically illustrates an energy storage system according to one or more embodiments.

Referring to FIG. 1, an ESS 1 according to one or more embodiments includes a battery system 10, a plurality of battery management systems (BMS) 21, 22, and 23, an energy management system (EMS) 30, and a power conversion system (PCS) 40.

The battery system 10 may include a plurality of battery cells connected in series and/or in parallel to each other. For example, the battery system 10 may include a plurality of battery banks 100 electrically connected in series and/or in parallel to each other, and each of the battery banks 100 may include a plurality of battery racks 110 electrically connected to each other in series and/or parallel. In addition, each of the battery racks 110 may include a plurality of battery modules 111 electrically connected in series and/or in parallel to each other, and each of the battery modules 111 may include a plurality of battery cells electrically connected in series and/or in parallel to each other.

The battery system 10 may charge the battery cells using electrical energy supplied from a power system through the PCS 40, and electrical energy stored in the battery cells may be supplied to a power system through the PCS 40.

The PCS 40 may operate as a power conversion device that converts electrical characteristics (direct current (DC), alternating current (AC), voltage, frequency, etc.) to transfer electrical energy between the battery system 10 and the power system. Typically, in the battery system 10, electrical energy in the form of direct current (DC) is used, and electrical energy in the form of alternating current (AC) is used in the power system. Accordingly, the PCS 40 may transfer electrical energy stored in the battery system 10 to the power system through DC-AC conversion, and may transfer electrical energy supplied from the power system to the battery system 10 through AC-DC conversion.

In addition to the power conversion and distribution functions described above, the PCS 40 may control quality of electricity, such as active power and reactive power of the ESS 1, and may additionally perform a monitoring or control function of monitoring a voltage and an operating state of the ESS 1, a system-connected protection function of protecting the power system during a power outage, an independent operation function of operating the ESS 1 by utilizing the battery system 10, etc. even if there is no power.

The battery system 10 may be managed by BMSs 21, 22 and 23. The BMSs 21, 22, and 23 may monitor the state of the battery system 10 to control the battery system 10 to operate in an optimal state. To this end, the BMSs 21, 22, and 23 may perform a state-monitoring function of monitoring states (a voltage, a current, a temperature, a state of charge (SOC), a state of health (SOH), etc.) for the battery cells constituting the battery system 10, control functions (e.g., temperature control, cell-balancing control, etc.), protection functions of preventing states (e.g., an over-discharge, an over-charge, an over-current, etc.). Each of the BMSs 21, 22, and 23 may manage an operation of the corresponding battery bank 100, and any one of the BMSs 21, 22, and 23 (e.g., a master BMS 21) may manage operations of all battery banks 100 constituting the battery system 10.

Each of the BMSs 21, 22, and 23 may collect data related to the state of the battery cells from the corresponding battery bank 100 for state monitoring of the battery system 10. The battery racks 110 constituting each of the battery banks 100 may collect data related to the state of battery cells from the battery modules 111 belonging thereto, and may transmit the data to corresponding BMSs 21, 22, and 23. The battery racks 110 constituting each of the battery banks 100 may communicate with other battery racks 110 or corresponding BMSs 21, 22, 23 through controller area network (CAN) communication, and may transmit and receive data (e.g., in a daisy chain manner).

Data collected from the battery racks 110 corresponding to each of the BMSs 21, 22, and 23 (hereinafter referred to as rack data) may be collected and managed by one master BMS 21. The slave BMSs 22 and 23 may transmit their collected rack data to the master BMS 21 in a daisy chain manner, and the master BMS 21 may manage them in accordance with the rack data that the master BMS 21 collects. In addition, if data transmission is requested from the EMS 30, the master BMS 21 may collect the rack data received from the battery racks 110 to transfer the rack data to the EMS 30.

The EMS 30 is an integrated control device that monitors and controls power use of the power system and power supply of the ESS 1 in real time for efficient energy management of the ESS 1. The EMS 30 monitors the state of the entire system constituting the ESS 1 (the battery system 10, the BMSs 21, 22, and 23, and the PCS 40), and may control the operation of the ESS 1.

The EMS 30 may receive rack data collected from the battery system 10, and BMS data indicating a state of the BMS from the master BMS 21, to monitor the states of the battery system 10 and the BMSs 21, 22, and 23.

In the meantime, if the master BMS 21 communicates with other BMSs 22 and 23 through CAN communication in a process of collecting rack data of each battery bank 100, a significant time delay may occur until rack data is received from the slave BMSs 22 and 23. Accordingly, transmission control protocol/Internet protocol (TCP/IP) communication technology may be used to transmit and receive data between or amongst the BMSs 21, 22, and 23.

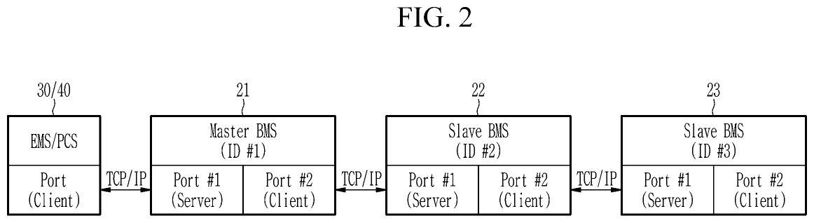

FIG. 2 illustrates a view for describing a communication method between the BMSs 21, 22, and 23 in the ESS 1 according to one or more embodiments.

Referring to FIG. 2, the BMSs 21, 22, and 23 may each include two physical TCP/IP ports Port #1 and Port #2 to implement a daisy chain transmission structure based on TCP/IP communication. Each of the BMSs 21, 22, and 23 may communicate as a server using a Port #1 and as a client using a Port #2 among the two ports. That is, each of the BMSs 21, 22, and 23 may receive a data transmission request from another client through the Port #1,and may transmit data to the corresponding client in response to the request. In addition, each of the BMSs 21, 22, and 23 may transmit a data transmission request to another server through the Port #2,and may receive data from the corresponding server as a response to the request.

The master BMS 21 may also communicate with the EMS 30 and the PCS 40 based on TCP/IP. If the master BMS 21 receives a data transmission request through its own Port #1 from the EMS 30 or the PCS 40 operating as a client, corresponding data may be transmitted to the EMS 30 or the PCS 40 through the Port #1.

For TCP/IP communication, different identification information (e.g., different IDs) may be respectively allocated to the BMSs 21, 22, and 23. Taking FIG. 2 as an example, ID #1 may be assigned to the master BMS 21, and ID #2 and ID #3 may be assigned to the slave BMSs 22 and 23, respectively. The ID of each of the BMSs 21, 22, and 23 may be set by a manager of the ESS 1, and may also be set automatically by the EMS 30 or the master BMS 21. The ID assigned to each of the BMSs 21, 22, and 23 may be collected and managed by the master BMS 21.

If the IDs of the BMSs 21, 22, and 23 are determined, an IP of each of the BMSs 21, 22, and 23 used for TCP/IP communication in the internal network system of the ESS 1 may be automatically set. In addition, each of the BMSs 21, 22, and 23 may be allocated a data zone within a transmission frame used in TCP/IP communication from the network system based on the ID assigned to it. Devices communicating through TCP/IP communication in the ESS 1 may transmit and receive data using Modbus protocol-based transmission frames.

If each of the BMSs 21, 22, and 23 is assigned its own data zone within a transmission frame, rack data received from the corresponding battery bank 100 may be updated in a corresponding data zone.

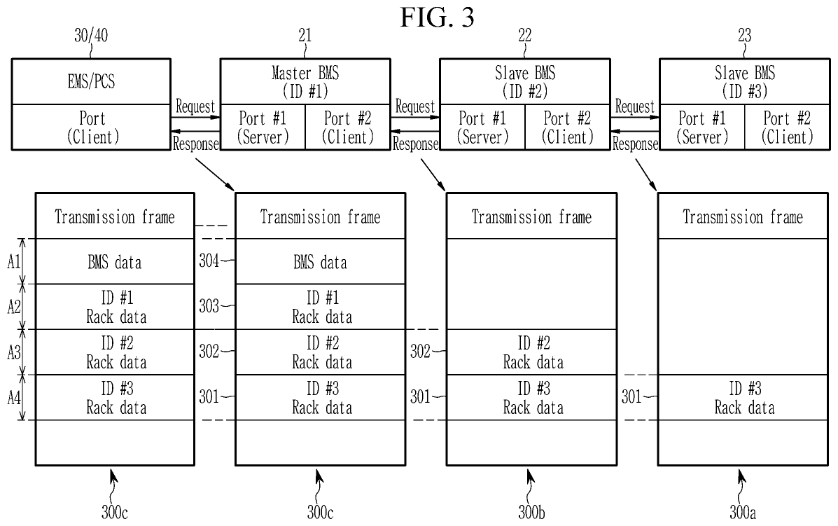

FIG. 3 illustrates a view for describing a method of transferring rack data collected by the BMSs 21, 22, and 23 in the ESS 1 according to one or more embodiments.

The slave BMS 23 may check that it is a slave BMS positioned in a lowest stage based on the ID assigned to each of the BMSs 21, 22, and 23. Accordingly, the slave BMS 23 omits an operation for receiving rack data from another BMS. The slave BMS 23 may check a data zone A4 assigned to it within a transmission frame 300a based on its own ID (ID #3). If the slave BMS 23 receives rack data 301 from the battery bank 100 it manages, a transmission frame 300a may be updated by inserting the received rack data 301 into the data zone A4 allocated thereto.

If the slave BMS 23 receives a rack data transmission request from the slave BMS 22 positioned in its upper stage through its own Port #1 (server), It may transmit the updated transmission frame 300a to the slave BMS 22 through its Port #1 (server).

The slave BMS 22 may check that the slave BMS 23 is located in its lower stage based on the ID assigned to each of the BMSs 21, 22, and 23. The slave BMS 22 checking this may transmit a rack data transmission request to the slave BMS 23 through its own Port #2 (client). Then, the slave BMS 22 may receive the transmission frame 300a from the slave BMS 23 through its own Port #2 (client) as a response thereto. In addition, the slave BMS 22 may generate a transmission frame 300b by receiving rack data 302 from the battery bank 100 managed by the slave BMS 22, and updating the transmission frame 300a to include the same. The slave BMS 22 may check a data zone A3 assigned to it within the transmission frame 300a based on its own ID (ID #2), and may insert the rack data 302 into the corresponding data zone A3.

If the slave BMS 22 receives a rack data transmission request from the master BMS 21 through its own Port #1 (server), it may transmit the generated transmission frame 300b to the master BMS 21 through its Port #1 (server).

The master BMS 21 may check that it is the master BMS based on the ID assigned to each of the BMSs 21, 22, and 23, and may also check how many slave BMSs 22 and 23 are connected to the battery system 10. After checking this, the master BMS 21 may transmit a rack data transmission request to the slave BMS 22 positioned in its lower stage using the IDs (ID #2 and ID #3) assigned to each of the slave BMSs 22 and 23. Then, the master BMS 21 may receive the transmission frame 300b from the slave BMS 22 through its own Port #2 (client) as a response thereto. In addition, the master BMS 21 may generate a transmission frame 300c by receiving rack data 303 from the battery bank 100 managed by the master BMS 21, and updating the transmission frame 300b to include the same. The master BMS 21 may check a data zone A2 assigned to it within the transmission frame 300b based on its own ID (ID #1), and may insert the rack data 303 into the corresponding data zone A2.

The transmission frame may further include the data zone A1 allocated to BMS data 304. In this case, the master BMS 21 may insert BMS data into the data zone A1 allocated to the BMS data 304 in a transmission frame 300c. The BMS data 304 may include information obtained by monitoring the battery system 10 by the BMS 21, 22, and 23, control state information of the battery system 10, and the like.

If the master BMS 21 receives a data transmission request from the EMS 30 or the PCS 40 through its own Port #1 (server), and the last updated transmission frame 300c may be transmitted to the EMS 30 or the PCS 40 through its own Port #1 (server). Accordingly, if the rack data of the battery system 10 is suitable, the EMS 30 or the PCS 40 may obtain rack data of all battery racks 110 constituting the battery system 10 by accessing only the master BMS 21.

As described above, in the ESS 1, the battery system 10 may be divided into the battery banks 100, and rack data of each of the battery banks 100 may be collected by different BMSs 21, 22, and 23. In addition, rack data collected by each of the BMSs 21, 22, and 23 may be transmitted to the master BMS 21 in a daisy-chain manner through TCP/IP communication for collection and management. In this process, a path through which each of the BMSs 21, 22, and 23 receives transmission frames from other BMSs, and a path through which each of the BMSs 21, 22, and 23 receives rack data from the corresponding battery bank 100, may be distinguished. Thus, both operations may be performed in parallel. Accordingly, a time delay until the master BMS 21 collects rack data of all battery racks 110 constituting the battery system 10 may be shortened.

In the meanwhile, in FIG. 1 to FIG. 3, a number of battery banks 100 constituting the battery system 10 is three, and accordingly, a case where a number of BMSs is also three is illustrated only as an example. Numbers of battery banks 100 and BMSs may be changed according to a capacity suitable for the ESS 1 and the like.

In addition, in the above-described embodiments, a case of using TCP/IP communication technology has been described as an example to transmit or receive data in daisy chain between the BMSs 21, 22, and 23, and for the master BMS 21 to communicate with the EMS 30 or the PCS 40. However, other communication methods may be used for these communications. For example, in one or more other embodiments, user datagram protocol (UDP) communication technology may be used to transmit and receive data between the BMSs 21, 22, and 23 in a daisy chain manner. In addition, for example, in one or more other embodiments, the UDP communication technology may be used to communicate with the master BMS 21 and the EMS 30 or the PCS 40. Even when using UDP communication technology, the same method as in the above-described embodiments may be used for a communication structure of a daisy chain method through a port, a method for allocating a data zone within a transmission frame, and the like.

While embodiments of the present disclosure have been particularly shown and described with reference to the accompanying drawings, the specific terms used herein are only for the purpose of describing the disclosure and are not intended to define the meanings thereof or be limiting of the scope set forth in the claims. Therefore, a person of ordinary skill in the art will understand that various modifications and other equivalent embodiments of the present disclosure are possible. Consequently, the true technical protective scope of the present disclosure must be determined based on the technical spirit of the appended claims, with functional equivalents thereof to be included therein.

### Description of Some of the Reference Characters

| | | |
|---|---|---|
| 1: ESS | 10: battery system | 21, 22, 23: BMS |
| 30: EMS | 40: PCS | 100: battery bank |
| 110: battery rack | 111: battery module | |

What is claimed is:

1. An energy storage system comprising:
a battery system configured to comprise battery banks electrically connected to each other; and
battery management systems comprising first and second ports for transmission control protocol/Internet protocol (TCP/IP) communication, the battery management systems being configured to communicate with the battery banks, configured to receive state data from a corresponding one of the battery banks, and configured to communicate in a daisy chain manner with one another.

2. The energy storage system as claimed in claim 1, wherein the battery management systems are configured to perform communication as a server using the first port, and to perform communication as a client using the second port.

3. The energy storage system as claimed in claim 1, wherein IDs are respectively assigned to the battery management systems, and
wherein IPs of the battery management systems are set according to the IDs.

4. The energy storage system as claimed in claim 1, wherein IDs are respectively assigned to the battery management systems, and
wherein data zones in a transmission frame are respectively allocated according to the IDs.

5. The energy storage system as claimed in claim 4, wherein the battery management systems are configured to update the transmission frame by adding the state data of a corresponding one of the battery banks to the transmission frame, and to transmit the updated transmission frame to one of the battery management systems of an upper stage.

6. The energy storage system as claimed in claim 5, wherein, if the transmission frame is received from one of the battery management system of a lower stage, the battery management systems are configured to update the transmission frame by adding the state data of a corresponding one of the battery banks to the transmission frame received from the one of the battery management systems of the lower stage.

7. The energy storage system as claimed in claim 6, wherein a master battery management system of the battery management systems is configured to receive, from the one of the battery management systems of the lower stage, the transmission frame comprising the state data added by at least one slave battery management system of the battery management systems.

8. The energy storage system as claimed in claim 7, further comprising an energy management system configured to integrally manage an operation of the energy storage system, to communicate with the master battery management system through TCP/IP communication, and to access the master battery management system to receive the transmission frame from the master battery management system.

9. The energy storage system as claimed in claim 1, wherein the battery banks comprise racks electrically connected to each other and configured to communicate with each other through controller area network (CAN) communication, and
wherein the battery management systems are configured to receive the state data obtained from battery modules constituting a corresponding one of the racks in a daisy-chain manner based on CAN communication.

10. An energy storage system comprising:
a battery system configured to comprise battery banks electrically connected to each other; and
battery management systems comprising first and second ports for user datagram protocol (UDP) communication, the battery management systems being configured to communicate with the battery banks, configured to receive state data from a corresponding one of the battery banks, and configured to communicate in a daisy chain manner with one another.

11. The energy storage system as claimed in claim 10, wherein the battery management systems are configured to perform communication as a server using the first port, and to perform communication as a client using the second port.

12. The energy storage system as claimed in claim 10, wherein IDs are respectively assigned to the battery management systems, and
wherein IPs of the battery management systems are set according to the IDs.

13. The energy storage system as claimed in claim 10, wherein IDs are respectively assigned to the battery management systems, and
wherein data zones in a transmission frame are respectively allocated according to the IDs.

14. The energy storage system as claimed in claim 13, wherein the battery management systems are configured to update the transmission frame by adding the state data of a corresponding one of the battery banks to the transmission frame, and to transmit the updated transmission frame to one of the battery management systems of an upper stage.

15. The energy storage system as claimed in claim 14, wherein, if the transmission frame is received from one of the battery management system of a lower stage, the battery management systems are configured to update the transmission frame by adding the state data of a corresponding one of the battery banks to the transmission frame received from the one of the battery management systems of the lower stage.

16. The energy storage system as claimed in claim 15, wherein a master battery management system of the battery management systems is configured to receive, from the one of the battery management systems of the lower stage, the transmission frame comprising the state data added by at least one slave battery management system of the battery management systems.

17. The energy storage system as claimed in claim 16, further comprising an energy management system configured to integrally manage an operation of the energy storage system, to communicate with the master battery management system through UDP communication, and to access the master battery management system to receive the transmission frame from the master battery management system.

18. The energy storage system as claimed in claim 10, wherein the battery banks comprise racks electrically connected to each other and configured to communicate with each other through controller area network (CAN) communication, and
wherein the battery management systems are configured to receive the state data obtained from battery modules constituting a corresponding one of the racks in a daisy-chain manner based on CAN communication.
